(19) United States
(12) Patent Application Publication
(10) Pub. No.: US 2024/0168485 A1
(43) Pub. Date: May 23, 2024

(54) SYSTEM AND METHOD FOR MINIMIZING TRAJECTORY ERROR USING OVERHEAD FEATURES

(71) Applicant: Cyberworks Robotics Inc., Oro Medonte (CA)

(72) Inventor: Vivek BURHANPURKAR, Oro Medonte (CA)

(21) Appl. No.: 18/517,895

(22) Filed: Nov. 22, 2023

Related U.S. Application Data
(60) Provisional application No. 63/427,271, filed on Nov. 22, 2022.

(51) Int. Cl. G05D 1/02

(52) U.S. Cl. CPC G05D 1/0251; G05D 1/0234

(57) ABSTRACT

Autonomous vehicles utilize sensors to determine their position on the ground. These sensors suffer from cumulative errors which cause the vehicle's position to be compromised. The present invention eliminates such error in the orthogonal axis from the direction of travel. The present invention provides a system and method for navigating an autonomous vehicle, using various overhead features. A vision subsystem comprises at least one camera pointed towards the ceiling. The camera is preferably pointed at a pitch angle of 90 degrees with respect to the vehicle, and is pointed overhead the autonomous vehicle towards the ceiling. The vision subsystem scans the ceiling features of the building the autonomous vehicle is in, and is able to self-determine which ceiling features it will utilize for navigation while minimizing drift errors, allowing the vehicle to maintain a straight path without requiring the installation of any additional infrastructure on the ceiling.

### RELATED APPLICATION

This application claims priority from U.S. Application Ser. No. 63/427,271 filed Nov. 22, 2022, which is incorporated herein by reference in its entirety.

### FIELD

The present disclosure is directed to a system and method for navigating an autonomous vehicle using overhead features.

### BACKGROUND

Some autonomous vehicles designed to be used in indoor environments may use ceiling fixtures or lines to help with navigation. For example, U.S. Pat. No. 4,933,864A uses ceiling light fixtures to guide an autonomous vehicle using a camera. However, this method is highly dependent on the availability of ceiling lights, and their close proximity from each other which makes it impractical in many types of buildings, and applications such as warehouses and/or greenhouses.

As another example, U.S. patent Ser. No. 10/612,939B2 uses a series of landmarks on the ceiling. These landmarks have to be manually set, and then a map is created of the ceiling landmarks. Therefore, the system is not applicable to a generic environment without mounting the landmarks in advance. A similar system is also described in Hongbo Wang, Hongnian Yu, Lingfu Kong, “Ceiling Light Landmarks Based Localization and Motion Control for a Mobile Robot,” 2007 IEEE International Conference on Networking, Sensing and Control, where ceiling lights were used as landmarks for autonomous navigation of a mobile robot.

Disclosed in Wang, Wenjuan & Luo, Zhendong & Song, Peipei & Sheng, Shili & Rao, Yimei & Soo, Yew & Yeong, Che & Duan, Feng. (2017), “A ceiling feature-based vision control system for a service robot”, pp. 6614-6619, 10.23919/ChiCC.2017.8028405, is a combination of ceiling line (discernable lines on the ceiling) detection and feature detection used to provide a robot with orientation corrections. Although this method is able to navigate a robot through a path, it has an accumulated error up to 10%, which is quite significant in mission-critical applications. This error can be attributed to an attempt to correct robot orientation, rather than its position.

Other prior art examples use ceiling lines, and try to determine and maintain a directional angle. However, such a system will result in a large error over longer distances.

Another prior art system attempts to measure the distance of movement of ceiling lines in the field of view of an upwardly facing camera to determine the rate of misalignment of the vehicle's trajectory with respect to such corresponding ceiling lines. However, this method requires a highly accurate depth camera to measure the exact height of the lines of interest such that the actual distance of movement of the lines can be calculated via linear algebra. It may therefore be costly to implement such a navigation system.

Another prior art system creates maps from ceiling lines, and measures the location and trajectory of the vehicle with respect to these ceiling feature-based maps. However, this method suffers from loss of localization due to either the absence of sufficient numbers of ceiling features or the presence of repetitive features.

Furthermore, these prior art systems often require pre-designated, continuous, and permanent ceiling lines to be functional.

What is needed is an improved system and method which overcomes at least some of these limitations in the prior art.

### SUMMARY

The present disclosure is directed to a system and method for navigating an autonomous vehicle, using various overhead features.

In this disclosure, the following defined terms are used:
ceiling feature: visible elements on a ceiling of a building including, but not limited to, suspended grids, ceiling tiles, supports, support beams, hanging pipes, pipes, ducts, strapping, conduits, supports, rods, wires, lighting, skylights, etc.
ceiling line: any visible element in a ceiling feature that is straight in nature and can be detected as a line in 2D.
pathway: lengths or regions of space inside a building connecting one point in the building to another point through which people or vehicles are allowed to move including, but not limited to, corridors, hallways, aisles, marked lanes, and unmarked lanes.
best line: a ceiling line calculated to have the highest metric based on a set of heuristics from all candidate ceiling lines detected in a current image frame. In an embodiment, the best line is selected on the basis of being primarily the most parallel to the orientation of the vehicle and secondarily on the basis of being the most prominent in regard to its features including but not limited to length, width, etc. such that it can serve as a useful reference for maintaining a trajectory parallel to the desired pathway.
reference line: an imaginary line centered on the camera's vertical field of view and is static in the camera view. It is used to provide a stable reference for drift calculations between the best lines in two successive image frames.
drift: a deviation from a straight path substantially parallel to the best line.
marker: a visual or wireless marker such as fiducial tags, QR codes, NFC (near-field communication) tags, RFID (radio frequency identification) tags, ultra-wide band transmitters, or any other kind that enables the robot to detect them when it gets close.
dead reckoning: a process of estimating the robot's position based on a known initial position and orientation and using the robot's proprioceptive sensors to measure its motion including velocity, heading, and time to propagate its motion using the robot's mathematical model and find its new position and orientation.

In an embodiment, a vision subsystem comprises at least one camera pointed towards the ceiling. The camera is preferably pointed at a pitch angle of 90 degrees with respect to the vehicle, and is pointed straight overhead the autonomous vehicle towards the ceiling. However, it will be appreciated that the system will still work if the camera is not pointed perfectly at 90 degrees. Furthermore, the camera can be fitted with a lens suitable for the operating environment. For example, a wide angle lens (a ˜24 mm focal length lens on a 35 mm full frame sensor) has a maximum diagonal angle of view of approximately 84 degrees. A normal lens (a ˜50 mm focal length lens on a 35 mm full frame sensor) has a maximum diagonal angle of view of approximately 47 degrees. The camera may also be fitted with a zoom lens having a zoomable range of focal lengths to achieve a suitable field of view for a given operating environment, in part based on the ceiling height.

We note that many of the pipes, conduits, structural members, and wires in the ceilings of commercial buildings are typically purposefully installed such that they are typically (a) straight and (b) aligned with the building's major pathways. The result is that the best lines above a given pathway will have the same orientation as the pathway below it. The present system and method utilizes this correlation to eliminate drift in the direction orthogonal to the direction of the pathway over long distances.

The vision subsystem scans the ceiling features in the pathway in which the autonomous vehicle is located, and is able to self-determine which ceiling features (e.g. lines, landmarks, a combination of these features) it will utilize for navigation in order to minimize drift errors. This allows the autonomous vehicle to maintaining a path in precisely the same orientation as the best line in each image frame, and as a result, maintain the precise orientation of the desired pathway in the building without requiring the installation of any additional infrastructure on the ceiling and irrespective of repetitive patterns in the ceiling or changing features due to dynamic lighting conditions.

In another embodiment, there is disclosed a system and method which uses naturally occurring lines in the ceiling for minimizing drift. Advantageously, the present method requires no predesignated lines or lanes to be purposely marked on a ceiling, and may identify which ceiling lines to use as the best line on the fly for navigation. The ceiling lines may be non-continuous, and may have a disjointed shape which prior art systems would not be able to use. Furthermore, the system and method may use different ceiling lines or ceiling features to compute different best lines depending on the lighting conditions which may vary according to the time of day if there are windows, or with changes in the ceiling infrastructure.

In another embodiment, the system and method self-determines and extracts the most suitable ceiling lines or ceiling features based on existing lighting conditions, and any changes to the lighting conditions or changes to the ceiling features. As changing lighting conditions may affect which ceiling lines or ceiling features are the most prominent, depending on contrast, reflectivity, etc., the camera can pick up different candidate ceiling features or ceiling lines at different times of day or year, based on the ambient lighting that is illuminating the ceiling features and ceiling lines. Therefore, the system may not choose the same “best line” from the candidate ceiling lines each time.

The vast majority of navigation error or drift of an autonomous vehicle (errors in the vehicle's calculated position relative to its actual position or ground truth) typically occurs in a direction perpendicular to the direction of the pathway in which the autonomous vehicle is moving, compared to the magnitude of errors in the direction of the pathway itself. This is because small errors in vehicle orientation may result in a cumulative drift error which may become quite large.

In an embodiment, the present system and method detects the position of any straight ceiling features, disregards those features that are substantially orthogonal to the direction of orientation of the vehicle. As the autonomous vehicle moves, the vision subsystem monitors the movement of the best line from one image frame to the next image frame (in the field of view of a ceiling-facing camera) in a direction perpendicular to the direction of the best line, as the vehicle proceeds along the pathway.

In an embodiment, the present system and method ensures that (a) a vehicle that is misaligned with the direction of the pathway becomes automatically aligned and (b) remains aligned as it navigates along the pathway, keeping drift errors within a maximum acceptable threshold (substantially near zero error).

In commercial buildings, various structural features in the ceilings (e.g. lines formed by pipes, conduit, strappings, structural support beams, etc.) have the same orientation as key traffic pathways (e.g. corridors, etc.). In the present discussion, such ceiling lines may be candidates for selection by the system for a “best line” to be used at a given point in time.

As noted earlier, the prior art has attempted to detect the angle of orientation of these best lines, and maintain an autonomous vehicle's orientation at the same angle in order to reduce the extent of the vehicle's drift in a direction lateral (orthogonal) to the direction of the pathway. This approach will result in an unacceptable amount of drift error, because even a small unavoidable mechanical variation in the orientation will result in a large cumulative lateral error after a long distance of travel of the autonomous vehicle along a pathway.

Furthermore, if the initial orientation of the vehicle is not exactly aligned with the pathway, such that the initial orientation would eventually cause the vehicle to drift laterally out of the outer bounds of the pathway, the present system and method utilizes a vision feedback control loop algorithm to orient the vehicle so as to keep the best line's lateral position steady at an initial position. This causes the autonomous vehicle to self-correct, and change its orientation to maintain lateral movement of the best line at or near zero and thereby maintain the same direction of motion as the pathway. Another advantage of the present system and method is that it does not require the best lines to remain the same one day to the next, nor does it require a best line to be visible in the field of view of the camera for the entire length of the straight path to be traversed. Rather, the best line features on the ceiling can change frequently, and along the pathway due to changes in the structural elements in the ceiling, lighting conditions or other causes. Thus, the present system and method offers great robustness in real world conditions.

In an embodiment, the present system and method calculates the movement of best lines in the field of view of a camera mounted on the autonomous vehicle from one image frame to the next image frame, and maintains the vehicle's orientation such that the lateral position of the best line remains steady in the camera's field of view from one image frame to the next image frame. That is to say, the best line maintains its lateral position in the FOV of the camera, which means that the vehicle is not drifting laterally.

Various algorithms may be used, including but not limited to, linear geometry math, machine learning, behavioral cloning, optical flow, machine learning optical flow, various feedback motion control systems, etc., to calculate the change in lateral position of the best line from one image frame to the next image frame and to continuously change the orientation or trajectory of the vehicle such that the best line remains steady in the orthogonal direction to the orientation of pathway and/or best line. Another embodiment describes the use of a “reference line” to calculate the lateral drift of the best line from one image frame to the next, but any number of methods known to those skilled in the art could be used instead to calculate the drift of the best line from one image frame to the next.

More generally, the present system and method is not limited to calculation of lateral movement of the best line in one image frame compared to the next image frame, but instead, is extensible to calculation of the lateral movement of the best line in a group of image frames over time. For example, we can calculate the running average or mean value of the lateral position of the best line in a set of image frames, and compare them to the running average or mean value of the lateral position of the best line in a subsequent set of image frames to determine the drift of the vehicle in the pathway over time.

More generally, the present system and method recognizes that any best lines that have been identified will drift laterally across the field of view of an upward pointing camera if the vehicle is drifting orthogonally to the direction of the best lines. As will be described in further detail below, the best lines are chosen based on heuristics of the ceiling line parameters, however other heuristics or Machine Learning algorithms could also be used to select the best line, including but not limited to the heuristic algorithm provided here. In addition, the process of maintaining the stability of the best line detection and drift calculation can utilize any number of motion control techniques knows to those skilled in the art, including but not limited to the process described here.

Advantageously, by minimizing drift error, the present system and method does not require knowledge of the exact distance of drift and therefore does not require any depth information, nor restrict the height of the ceiling features in use. It is instead sufficient to provide a motion feedback loop that keeps the drift to near zero by counting only the number of 2D pixels of the camera's image sensor, without the need for calculation of the actual measured distance of drift, which would instead require a more expensive 3D measuring device rather than a 2D camera. This allows an autonomous vehicle or robot to navigate in a complex network of straight paths in many different environments.

Furthermore, the present system and method allows a vehicle that is mis-oriented to the pathway, to automatically correct its orientation to the pathway as soon as it begins moving forward. This is true both for the initial starting position as well as after making a turn onto a new pathway orthogonal to the prior pathway (a turning point).

### BRIEF DESCRIPTION OF THE DRAWINGS

The present invention, and the objects of the invention will become apparent when consideration is given to the following detailed description thereof. Such description makes reference to the annexed drawings, wherein:

FIGS. 1A-1C show an illustrative view of a ceiling, and calculation of drift between two consecutive frames with slight change in best line position and no change in orientation. A and B show frames 1 and 2 respectively while C shows a combined view of the best line in both frames. (1) is the reference line, (2) is the best line in frame 1 and (3) is the best line in frame (2). In C, the drift is calculated as (4).

FIG. 2A-2C show an illustrative view of a ceiling, and of drift using two frames with change in best line position and orientation. Interpolation (4) is utilized to maintain a constant reference best line for more consistent drift calculations. FIG. 2A and FIG. 2B show frames 1 and 2 respectively while FIG. 2C shows a combined view of the best line in both frames. The reference line (1) is the same as shown in FIGS. 1A—1C and (5) is the drift that is calculated.

FIGS. 3A-3F show an illustrative example of an illustrative heuristic algorithm for identifying and selecting a “best line” in accordance with an illustrative embodiment.

FIG. 4 shows an illustrative system architecture including steps involved in calculating velocity commands to be sent to an autonomous vehicle.

FIG. 5A shows an example of a robot set up in an environment where markers indicate system start and switches. Robot is shown as (1) in an indoor environment (2) with 4 visual markers spread out along the desired path (3).

FIG. 5B shows an example of a robot detecting a first marker and decoding information that corresponds to initiating a ceiling drift control system to keep a straight path (4).

FIG. 5C shows an example of a robot detecting a second marker, and decoding information that corresponds to stopping the ceiling drift control system and making an illustrative 90 degree turn (5) using dead-reckoning.

FIG. 5D shows an example of a robot detecting a third marker, and decoding information that corresponds to initiating ceiling drift system and keeping a straight path (6).

FIG. 5E shows an example of a robot detecting a fourth marker, and decoding information that correspond to stopping the ceiling drift system and using localization techniques appropriate for outdoor environments (7) such as dead-reckoning and sensor fusion with GNSS data to navigate an outdoors path (8).

FIG. 6 shows schematic diagram of a generic computing device which may provide a platform for one or more embodiments of the present system and method.

### DETAILED DESCRIPTION

As noted above, the present disclosure is directed to a system and method for navigating an autonomous vehicle, using various overhead features.

In an embodiment, a vision subsystem comprises at least one camera pointed towards the ceiling. The camera is preferably pointed at a pitch angle of 90 degree with respect to the vehicle, and is pointed straight overhead the autonomous vehicle towards the ceiling. However, it will be appreciated that the system will still work if the camera is not pointed perfectly at 90 degrees. Furthermore, the camera can be fitted with a lens suitable for the operating environment. For example, a wide angle lens (a ˜24 mm focal length lens on a 35 mm full frame sensor) has a maximum diagonal angle of view of approximately 84 degrees. A normal lens (a ˜50 mm focal length lens on a 35 mm full frame sensor) has a maximum diagonal angle of view of approximately 47 degrees. The camera may also be fitted with a zoom lens having a zoomable range of focal lengths to achieve a suitable field of view for a given operating environment, in part based on the ceiling height.

We note that many of the pipes, conduits, structural members, and wires in the ceilings of commercial buildings are typically purposefully installed such that they are typically (a) straight and (b) aligned with the building's major pathways. The result is that the best lines above a given pathway will have the same orientation as the pathway below it. The present system and method utilizes this correlation to eliminate drift in the direction orthogonal to the direction of the pathway over long distances.

The vision subsystem scans the ceiling features in the pathway in which the autonomous vehicle is located, and is able to self-determine which ceiling features (e.g. lines, landmarks, a combination of these features) it will utilize for navigation in order to minimize drift errors. This allows the autonomous vehicle to maintaining a trajectory in precisely the same orientation as the Best Line in each image frame, and as a result, maintain the precise orientation of the desired pathway in the building without requiring the installation of any additional infrastructure on the ceiling and irrespective of repetitive patterns in the ceiling or changing features due to dynamic lighting conditions.

In another embodiment, there is disclosed a system and method which uses naturally occurring lines in the ceiling for minimizing drift. Advantageously, the present method requires no predesignated lines or lanes to be purposely marked on a ceiling, and may identify which ceiling lines to use as the best line on the fly for navigation. The ceiling lines may be non-continuous, and may have a disjointed shape which prior art systems would not be able to use. Furthermore, the system and method may use different ceiling lines or ceiling features to compute different best lines depending on the lighting conditions which may vary according to the time of day if there are windows, or with changes in the ceiling infrastructure.

In another embodiment, the system and method self-determines and extracts the most suitable ceiling lines or ceiling features based on existing lighting conditions, and any changes to the lighting conditions or changes to the ceiling features. As changing lighting conditions may affect which ceiling lines or ceiling features are the most prominent, depending on contrast, reflectivity, etc., the camera can pick up different candidate ceiling features or ceiling lines at different times of day or year, based on the ambient lighting that is illuminating the ceiling features and ceiling lines. Therefore, the system may not choose the same “best line” from the candidate ceiling lines each time.

The vast majority of navigation error or drift of an autonomous vehicle (errors in the vehicle's calculated position relative to its actual position or ground truth) typically occurs in a direction perpendicular to the direction of the pathway in which the autonomous vehicle is moving, compared to the magnitude of errors in the direction of the pathway itself. This is because small errors in vehicle orientation may result in a cumulative drift error which may become quite large.

In an embodiment, the present system and method detects the position of any straight ceiling features, disregards those features that are substantially orthogonal to the direction of orientation of the vehicle. As the autonomous vehicle moves, the vision subsystem monitors the movement of the best line from one image frame to the next image frame (in the field of view of a ceiling-facing camera) in a direction perpendicular to the direction of the best line, as the vehicle proceeds along the pathway.

In an embodiment, the present system and method ensures that (a) a vehicle that is misaligned with the direction of the pathway becomes automatically aligned and (b) remains aligned as it navigates along the pathway, keeping drift errors within a maximum acceptable threshold (substantially near zero error).

In commercial buildings, various structural features in the ceilings (e.g. lines formed by pipes, conduit, strappings, structural support beams, etc.) have the same orientation as key traffic pathways (e.g. corridors, etc.). In the present discussion, such ceiling lines may be candidates for selection by the system for a “best line” to be used at a given point in time.

As noted earlier, the prior art has attempted to detect the angle of orientation of these best lines, and maintain an autonomous vehicle's orientation at the same angle in order to reduce the extent of the vehicle's drift in a direction lateral (orthogonal) to the direction of the pathway. This approach will result in an unacceptable amount of drift error, because even a small unavoidable mechanical variation in the orientation will result in a large cumulative lateral error after a long distance of travel of the autonomous vehicle along a pathway.

Furthermore, if the initial orientation of the vehicle is not exactly aligned with the pathway, such that the initial orientation would eventually cause the vehicle to drift laterally out of the outer bounds of the pathway, the present system and method utilizes a vision feedback control loop algorithm to orient the vehicle so as to keep the best line's lateral position steady at an initial position. This causes the autonomous vehicle to self-correct, and change its orientation to maintain lateral movement of the best line at or near (approximately) zero and thereby maintain the same direction of motion as the pathway.

Another advantage of the present system and method is that it does not require the best lines to remain the same one day to the next, nor does it require a best line to be visible in the field of view of the camera for the entire length of the straight path to be traversed. Rather, the best line features on the ceiling can change frequently, and along the pathway due to changes in the structural elements in the ceiling, lighting conditions or other causes. Thus, the present system and method offers great robustness in real world conditions.

In an embodiment, the present system and method calculates the movement of best lines in the field of view of a camera mounted on the autonomous vehicle from one image frame to the next image frame, and maintains the vehicle's orientation such that the lateral position of the best line remains steady in the camera's field of view from one image frame to the next image frame. That is to say, the best line maintains its lateral position in the FOV of the camera, which means that the vehicle is not drifting laterally.

Various algorithms may be used, including but not limited to, linear geometry math, machine learning, behavioral cloning, optical flow, machine learning optical flow, various feedback motion control systems, etc., to calculate the change in lateral position of the best line from one image frame to the next image frame and to continuously change the orientation or trajectory of the vehicle such that the best line remains steady in the a orthogonal direction to the orientation of pathway and/or best line. Another embodiment describes the use of a “reference line” to calculate the lateral drift of the best line from one image frame to the next, but any number of methods known to those skilled in the art could be used instead to calculate the drift of the best line from one image frame to the next.

More generally, the present system and method is not limited to calculation of lateral movement of the best line in one image frame compared to the next image frame, but instead, is extensible to calculation of the lateral movement of the best line in a group of image frames over time. For example, we can calculate the running average or mean value of the lateral position of the best line in a set of image frames, and compare them to the running average or mean value of the lateral position of the best line in a subsequent set of image frames to determine the drift of the vehicle in the pathway over time.

More generally, the present system and method recognizes that any best lines that have been identified will drift laterally across the field of view of an upward pointing camera if the vehicle is drifting orthogonally to the direction of the best lines. As will be described in further detail below, the best lines are chosen based on heuristics of the line parameters, however other heuristics or Machine Learning algorithms could also be used to select the best line, including but not limited to the heuristic algorithm provided here. In addition, the process of maintaining the stability of the best line detection and drift calculation can utilize any number of motion control techniques knows to those skilled in the art, including but not limited to the process described here.

Advantageously, by minimizing drift error, the present system and method does not require knowledge of the exact distance of drift and therefore does not require any depth information, nor restrict the height of the ceiling features in use. It is instead sufficient to provide a motion feedback loop that keeps the drift to near zero (approximately zero) by counting only the number of 2D pixels of the camera's image sensor, without the need for calculation of the actual measured distance of drift, which would instead require a more expensive 3D measuring device rather than a 2D camera. This allows an autonomous vehicle or robot to navigate in a complex network of straight paths in many different environments.

Furthermore, the present system and method allows a vehicle that is mis-oriented to the pathway, to automatically correct its orientation to the pathway as soon as it begins moving forward. This is true both for the initial starting position as well as after making a turn onto a new pathway orthogonal to the prior pathway (a turning point).

Various illustrative embodiments of the system and method will now be described with reference to the drawings.

In an embodiment, as a first step, the present system and method uses a simple RGB or monochromatic camera pointed directly at the ceiling, preferably with a 90 degree pitch angle straight up with respect to the autonomous vehicle, to find ceiling lines that are nearly parallel to the desired trajectory of the vehicle (within a small threshold in orientation). In an embodiment, the image from the RGB camera is then sent to a computing device which runs all required computations in the remainder of the description. The computing device may be, for example, an edge computing device, an onboard embedded computing chip, or any other suitable computing device which may serve as a suitable platform for various embodiments, as generically shown and described further below.

In another embodiment, the vision system may employ in real-time a “post processing” step in which the raw image of all the lines can be enhanced in various useful ways, for example, in the case of several parallel lines that are side-by-side, the vision system can consolidate such parallel lines into a single center line. The vision system can also connect lines that are colinear but disconnected to convert several short, disconnected line segments into a single long line. The inventors believe that this is a significant improvement over the prior art, as this reduces the need to compute a new “best line” every time the previous best line ends due to a breakage in the line.

Once the previous best line is no longer visible in the image frame of the camera, the system stores the total lateral error in memory for future reference, and the system can start again by determining a new best line. In this case, the system cannot calculate the lateral change between the old best line and new best line because they have nothing to do with each other. So any drift that occurs between a best line and a new best line is lost in the case of a new best line detection. This can result in a miniscule lateral error depending on how far the vehicle drifts between the loss of the best line and selection of a new best line (depends on vehicle speed and framerate).

As a second step, the present system and method uses the best of these candidate ceiling lines (the “best line”) based on a heuristics combination of features including, but not limited to, length of the line, orientation of the line relative to the vehicle, and the proximity of line to center of field of view of the camera. In later frames, another heuristic is added to increase the priority of using the same best line rather than selecting a new best line.

Based on the heuristics, or alternatively another approach to select a suitable best line, a line score is calculated and the line with the highest score is chosen as the best line. As an illustrative example only, and not by way of limitation, the score may be calculated as follows:

score=λ₁*l+λ₂*w+λ₃*(posₓ−w_{image}/2)+λ₄*similarity(line,prev_{bestline})+λ₅θₗᵢₙₑ;

where
λᵢ, i=1 . . . 5, is the weight assigned to each feature, which is manually tuned based on the environment in the range of 0 to 1;
l and w are the length and width of the line respectively;
posₓ is the position of the line at the vertical center of the image along the x-axis of the image;
w_{image} is the width of the image;
similarity(line, prev_{bestline}) is a measure of the similarity between the current line and the previous best line; and
θₗᵢₙₑ is the orientation of the best line with respect to the vehicle, with parallel being θₗᵢₙₑ=0.

The similarity between the two lines is calculated using the minimum distance between the endpoints of the previous best line and any new possible best line. As a third step, as the vehicle moves, the present system and method measures the movement of the best line in a lateral direction to the orientation of the best line in the field of view of the camera. If there is no lateral movement of the line, then the vehicle must be moving nearly or exactly parallel to the best line, and hence to the desired pathway. However, if there is lateral movement of the best line, then the vehicle is not moving parallel to the desired pathway and a drift is calculated between two selected frames, or groups of frames, at a reference line. However, an abundance of other mathematical techniques could be used by those skilled in the art to calculate the drift between two best lines including but not limited to, for example, calculating the average lateral movement between the endpoints of the best lines rather than at a reference line, or at the midpoint of the best lines, rather than at a reference line, etc.

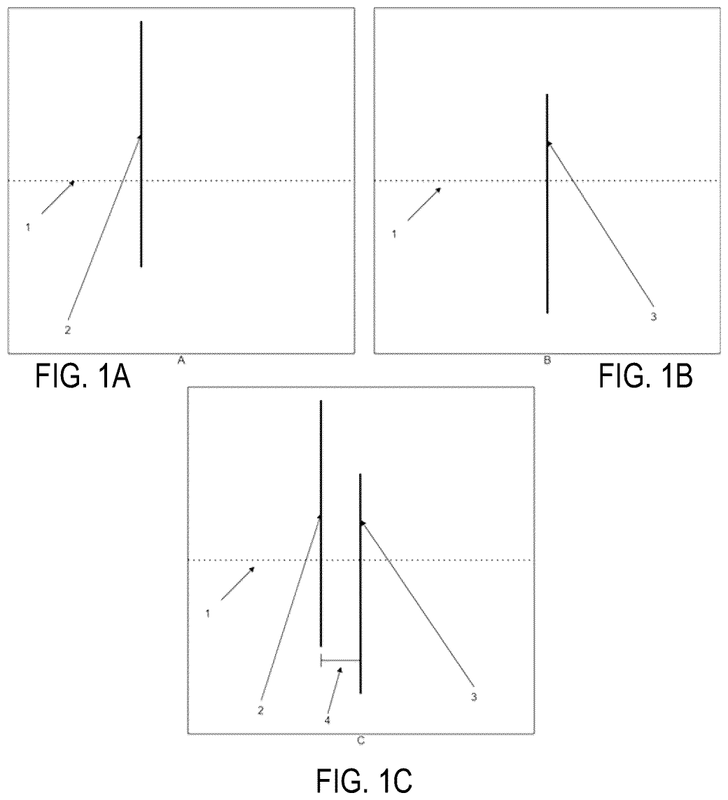

As an example, in FIGS. 1A-1C, the reference line labelled (1) is constant through both frames, labels (2) and (3) show the best lines in frames 1 and 2, respectively. Label (4) illustrates the drift between the best lines in the two consecutive frames.

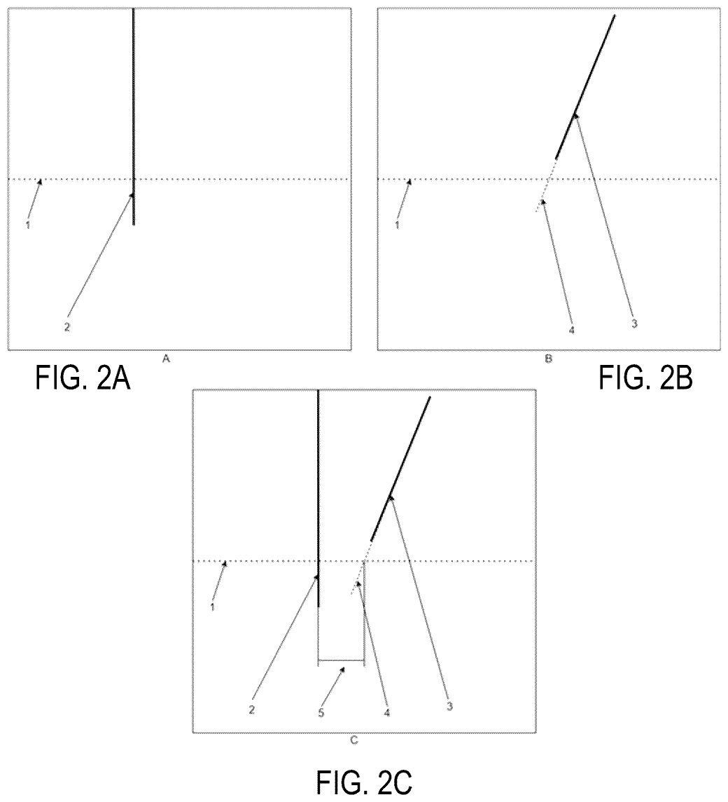

As a next step, if the best line's orientation is skewed and has a changing length within the image FOV, the calculation of the lateral drift of the line is achieved in the following novel manner:
a. Drift is calculated with respect to the reference line, defined as an imaginary line centered on the camera's vertical field of view and is static in the camera view. It is used to provide a fixed reference for drift calculations.
b. The calculation of drift achieves stability by always referencing the drift at the center of the camera frame's vertical field of view (FOV) as shown in FIGS. 1A—1C and FIGS. 2A-2C. All lines are interpolated to cover the vertical FOV and the calculation of drift is done by comparing the positions at that reference line, centered on the vertical FOV.
c. The system always interpolates the lines and calculates the lateral drift from a common reference point (center), this guarantees a consistent drift calculation that is robust to such changes in length and orientation as the robot moves and turns as shown in FIGS. 2A-2C. At a high frequency of detection, consecutive frames have very similar structures which leads to the same line being consistent between frames and allows for easier computation of drift between frames.

As a next step, in an illustrative embodiment, the present system and method uses a PID (proportional-integral-derivative) control loop to ensure that the lateral drift of the best line is maintained (e.g. near zero pixels of the camera frame) by control of the robot steering.

However, it will be appreciated that other types of control systems may also be used, including but not limited to fuzzy logic, MPC, Machine Learning, etc. When the line is no longer sufficiently long or disappears from the camera image frame, all lines in the image frame are analyzed to determine a new “best line”, and the total cumulative lateral drift associated with the previous best line is saved as the “previous best line” which is then added to the new best line's drift to control the lateral drift of the vehicle's trajectory. That is to say, that when a new “best line” is chosen that achieves higher scores using heuristics or other approaches known to those skilled in the art, the best line is switched to a new best line and the cumulative sum of the drift is kept to estimate the total drift from the original lateral position of the original best line. The method is repeated until the autonomous vehicle arrives at a turning point or endpoint in its trajectory, indicated by markers in the environment or a priori program instruction or other indication to change the vehicle's motion.

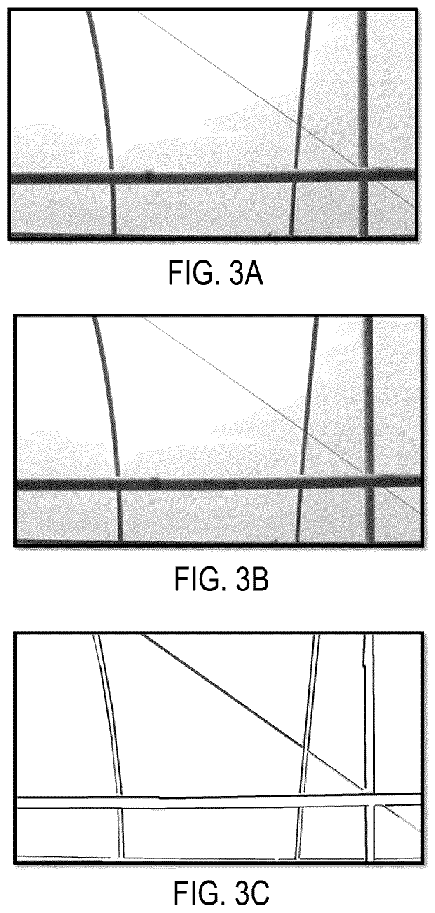

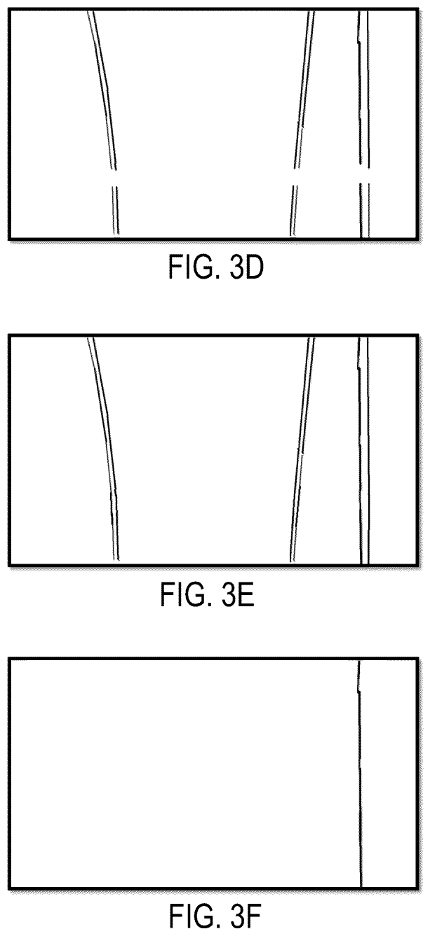

Now referring to FIGS. 3A-3F, shown is an illustrative heuristic “Algorithm 1” for identifying and selecting a “best line” in accordance with an illustrative embodiment. At step 3 of Algorithm 1, an image frame is obtained from a camera, as illustrated in FIG. 3A. In an embodiment, at step 4, the image frame is first converted to grayscale as shown in FIG. 3B.

At step 5 of Algorithm 1, the line detection algorithm is executed to extract all lines in the converted grayscale image frame, as shown in FIG. 3C.

At step 6 of Algorithm 1, lines within an angle threshold of the vertical axis of the frame are filtered and selected, as shown in FIG. 3D.

Lines that have an overlap of more than σ₍ₒᵥₑᵣₗₐₚ₎ are then joined, as shown in FIG. 3E. From this filed selection of lines, the best line is chosen based the highest score where:

score=λ1*l+λ2*w+λ3*(posₓ−w_{image}/2)+λ4*similarity(line,prev_{bestline})+λ5*θₗᵢₙₑ

where
λi, i=1 . . . 5 is the weight assigned to each feature;
l and w are the length and width of the line respectively;
posₓ is the position of the line at the vertical center of the image along the x-axis of the image;
w_{image} is the width of the image;
similarity(line, prev_{bestline}) is a measure of the similarity between the current line and the previous best line; and
θₗᵢₙₑ is the orientation of the best line with respect to the vehicle, with parallel being θₗᵢₙₑ=0.

Finally, FIG. 3F shows the “best line” that has been selected. In an embodiment, the best line is calculated each time when a new pathway is begun, and then again each time the best line is lost from the camera's image frame.

In an embodiment, the system and method checks for the lateral drift of the best line several times per second depending on vehicle speed, typically about 30 fps. However, it will be appreciated that this is illustrative and not limiting, and the rate may be higher or lower.

In another embodiment, the system and method employs an algorithm to search for a continuation of the best line in each successive frame, and if the system and method finds a line that appears to be the continuation of the previous best line, the system and method sticks with it. Otherwise the system and method starts from the beginning to find all candidate ceiling lines and then selects a new best line from those candidates.

So the lateral drift of the best line is tracked at a fixed framerate depending on vehicle speed, typically 30 fps. At each successive frame, the system and method checks to see if the former best line can be found, and if it cannot be found, then the system and method looks for a new best line from all the candidates. It is theoretically possible that each new frame may lose the best line and a new one must be found, but this is unlikely to happen.

Every time the system and method needs to find a new best line, the system and method is not able to calculate the lateral drift between the previous best line and the new best line, so this can result in the buildup of incremental lateral drift error if the system and method loses the best line too often, so it is desirable to have an algorithm that finds the old best line in each successive frame and continue to use that previous best line.

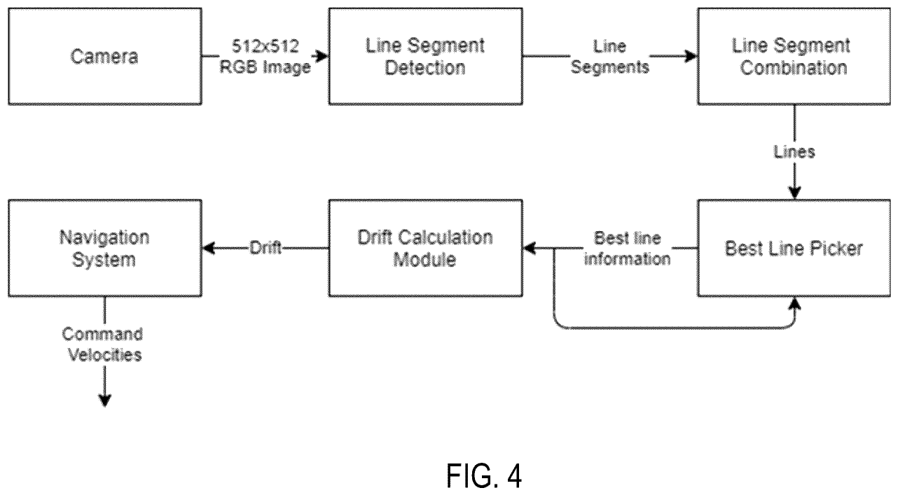

An architecture for performing the above in accordance with an illustrative embodiment is shown in FIG. 4.

In another embodiment, such turning points can be connected and transformed into a series of networks to create a complex path from one location to a distant destination.

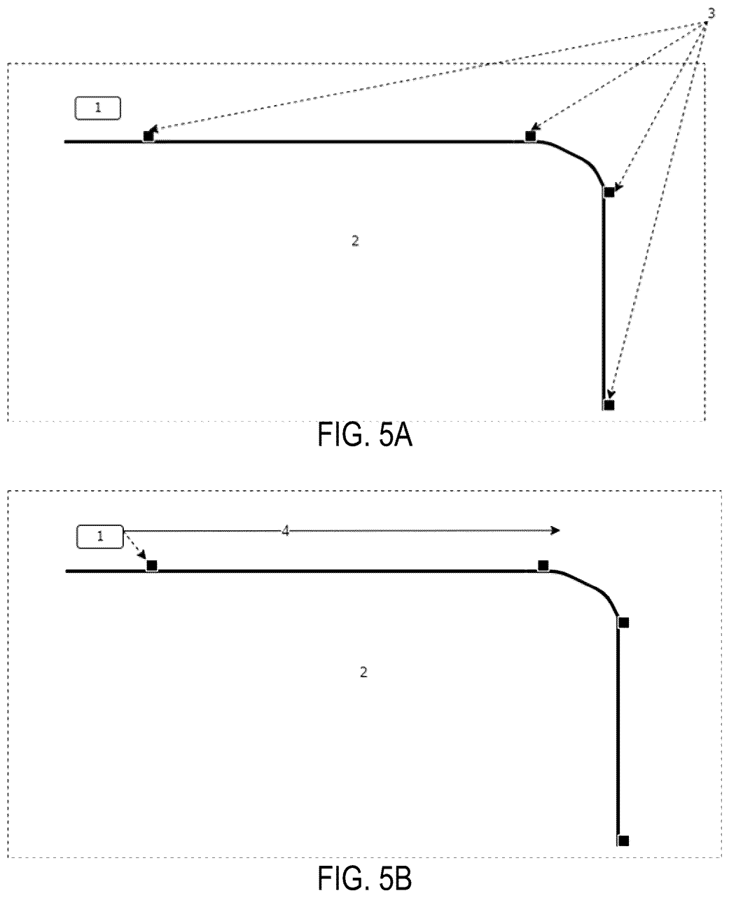

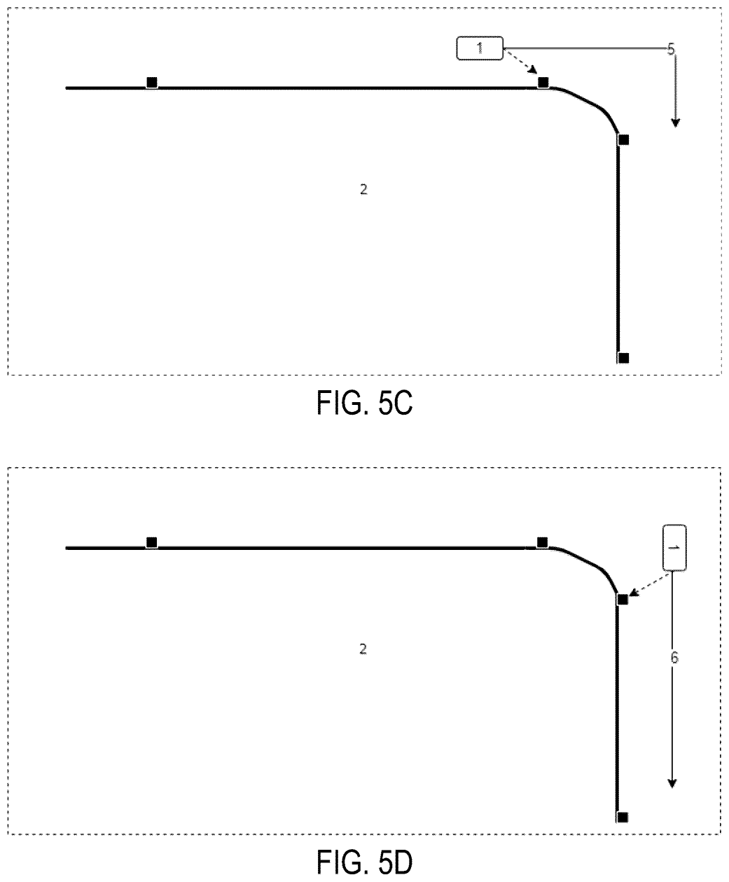

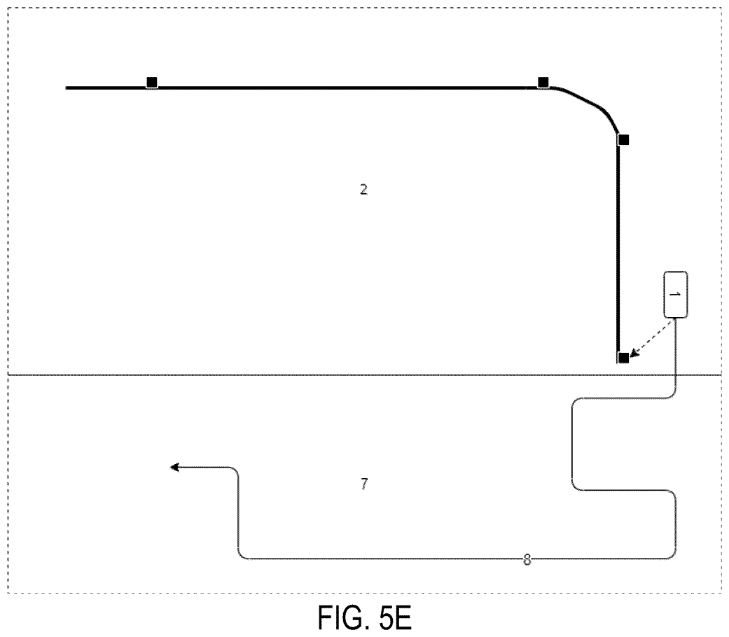

In another embodiment, in areas where there is an absence of appropriate ceiling lines, the system and method reverts to use of prior known methods. A software architecture that allows the system and method to switch on-the-fly between two or more heterogeneous methods of vehicle localization and/or mapping is believed by the inventor to be novel, and may be described as follows:
A) A novel method of switching the source of localization data employs a localization mode manager which uses the robot location and/or physical markers to act as preprogrammed switch points. This is illustrated in FIGS. 5A-5E and it allows the robot to navigate between indoor and outdoor environments, utilize other localization approaches where appropriate, and combine straight segments to create more complicated paths.
B) The localization mode manager is also able to detect when the ceiling lines are not appropriate using confidence scores and revert to a secondary localization mode to enable the robot to continue its task without interruption.

In another embodiment, the present system and method may be used in combination with markers to navigate through more complex environments. To do that, the autonomous vehicle or robot has to handle turns, which can be done in the following manner (as illustrated in FIGS. 5A-5E).

As shown in FIG. 5A, an autonomous vehicle or robot is placed at a starting pose that is nearly parallel to its path and at the correct lateral position.
Case 1: The robot is started and it starts travelling in a straight path while reducing drift using the present system and method
Case 2: The robot is able to see a fixed visual marker (labeled 3 in FIG. 5A) which is associated with a required lateral distance. The robot is then able to adjust its starting lateral position as required and then engages the ceiling drift detection system as described herein.

As shown in FIG. 5B, the robot moves along the longitudinal axis, it maintains its lateral position using the process described herein. At the end of the straight path a marker is found that marks the end of the segment. The segments are connected with turns and the information about the turn expected at that point is encoded in the marker.

As shown in FIG. 5C, at that marker, the robot deactivates the ceiling detection system and uses a taught path to make the turn.

Now referring to FIG. 5D, after the turn, the robot finds another marker which marks the start of the next segment.
Case 1: The robot directly engages the ceiling drift detection system and continues travelling in a straight line.
Case 2: The visual marker has data associated with it including a required lateral offset. The robot then adjusts its lateral position to match the marker information and then engages the ceiling drift detection system.

Now referring to FIG. 5E, the process is repeated between segments that are connected according to the full path the robot is expected to complete.

The robot accumulates the total drift over the frames, and only reacts to drift above a specified threshold. This allows the system to cancel out drifts due to vibration and avoid overcorrecting small drifts.

In the above described example, the present system and method eliminates the problems associated with prior art systems and methods, such as the need for expensive depth cameras or visual markers on the ceiling to monitor the distance to the ceiling. The present system and method also is not affected by the absence of sufficient ceiling lines to create a map, presence of repetitive lines which may cause a map to be disorienting, or the build-up of cumulative errors over long distances of motion.

### Use Cases

Various illustrative use cases will now be described.

In one example, the present system and method may be used to follow a substantially straight path using ceiling features and lines. The drift detection system allows maintaining a constant straight path with minimal drift from the starting point in the lateral direction.

In another example, the present system and method may be used to allow autonomous vehicles to follow a straight path in GPS-denied, indoor environments where the surroundings are always changing making most common approaches impractical. The invention allows a robot to navigate a complex network of straight paths with sparse features, repetitive patterns, or an environment that always changes. This makes autonomous navigation possible based on ceiling lines which are inherently available and substantially parallel to the paths the robot needs to traverse.

As another example, indoor autonomous vehicles are frequently required to traverse complex networks of straight paths, similar to a city map of streets. Prior art uses a method called Simultaneous Localization and Mapping (SLAM) as a means by which the vehicle is able to understand its real time location within such a map and then to determine how to move from one location in the map to another. SLAM suffers from poor performance in feature-sparse environments or feature-repetitive environments and often requires the use of a combination of expensive sensors such as LiDARs, depth cameras, IMU, etc. The present system and method uses an inexpensive monocular camera and is immune to feature sparseness or repetitiveness and can be used to connect straight paths by a descriptor of the turn angle at the intersection of each straight path (by means of a visual or non-visual marker) to create a complete description of the route to take.

As yet another example, an extension to the approach can use the global localization of the robot and the drift information to teach a complex route. Instead of following the line and minimizing the drift, the robot will learn the drift values at each position. The robot will then follow a teach-and-repeat paradigm where it repeats same drift it learnt. This will allow for more complex routes as per the user requirements.

As a further example, the present system and method may be used independent of any external marker to indicate where the system should start/stop, where to follow a taught turn, or allow the robot to initialize itself at a given lateral distance from the marker before starting to follow a straight path.

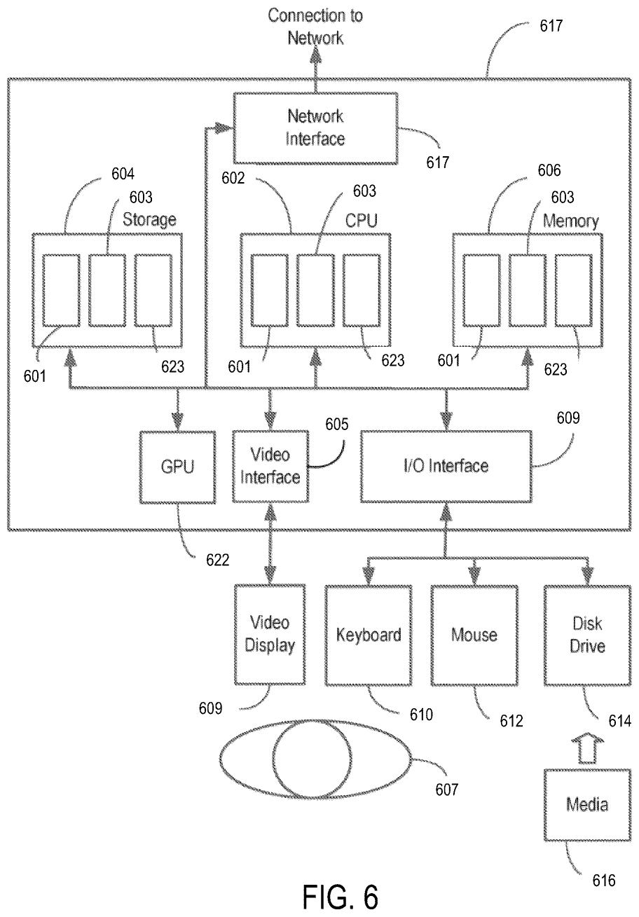

Now referring to FIG. 6, shown is a schematic block diagram of a generic computing device that may provide a suitable operating environment in one or more embodiments. A suitably configured computer device, and associated communications networks, devices, software and firmware may provide a platform for enabling one or more embodiments as described above. By way of example, FIG. 6 shows a generic computer device 600 that may include a central processing unit (“CPU”) 602 connected to a storage unit 604 and to a random access memory 606. The CPU 602 may process an operating system 601, application program 603, and data 623. The operating system 601, application program 603, and data 623 may be stored in storage unit 604 and loaded into memory 606, as may be required. Computer device 600 may further include a graphics processing unit (GPU) 622 which is operatively connected to CPU 602 and to memory 606 to offload intensive image processing calculations from CPU 602 and run these calculations in parallel with CPU 602. An operator 610 may interact with the computer device 600 using a video display 608 connected by a video interface 605, and various input/output devices such as a keyboard 610, pointer 612, and storage 614 connected by an I/O interface 609. In known manner, the pointer 612 may be configured to control movement of a cursor or pointer icon in the video display 608, and to operate various graphical user interface (GUI) controls appearing in the video display 608. The computer device 600 may form part of a network via a network interface 611, allowing the computer device 600 to communicate with other suitably configured data processing systems or circuits. A non-transitory medium 616 may be used to store executable code embodying one or more embodiments of the present method on the generic computing device 600.

Thus, in an aspect, there is provided a system and method to monitor lateral drift of a vehicle by using the lateral movement of only pre-existing ceiling lines, relative to an onboard camera's field of view, which are substantially parallel to the desired direction of vehicle motion.

In an embodiment, the system and method detects change in lateral position of the robot by tracking and comparing the position of a naturally occurring best line in the ceiling features.

In another embodiment, the system and method utilizes a vision subsystem, may comprise a monochrome or RGB camera pointed towards the ceiling, preferably at a 90 degrees pitch angle, and an edge computing device to detect all naturally occurring lines in the ceiling within the camera's field of view.

In another embodiment, the system and method utilizes heuristics based online parameters to identify the best line that is substantially parallel to the robot pose and a method to keep calculations consistent and robust with ceiling lines of changing length and orientation between frames due to robot motion by performing all drift calculation at a common reference line.

In another embodiment, the system and method utilizes line information including, for example, length, width, angle, position, and similarity measure to the previous best line to calculate a score that determines the best line to follow:

score=λ₁*l+λ₂*w+λ₃*(posₓ−w_{image}/2)+λ₄*similarity(line,prev_{bestline})+λ₅θₗᵢₙₑ;

where
λᵢ, i=1 . . . 5, is the weight assigned to each feature;
l and w are the length and width of the line respectively;
posₓ is the position of the line at the vertical center of the image along the x-axis of the image;
w_{image} is the width of the image;
similarity(line, prev_{bestline}) is a measure of the similarity between the current line and the previous best line; and
θₗᵢₙₑ is the orientation of the best line with respect to the vehicle, with parallel being θₗᵢₙₑ=0.

In another embodiment, the best line is interpolated to cross the reference line which is kept constant across all frames to ensure robust and consistent drift measurements.

In another embodiment, the system and method uses several markers, that the system and method is pre-programmed to recognize, that switch the system between drift correction using natural ceiling lines for straight motion and other localization and navigation methods for turns, allowing full navigation coverage in different environments including hybrid indoor-outdoor environments.

In another embodiment, the system and method can switch on/off the ceiling navigation system based on identifying that ceiling lines are not sufficient and switch source of navigation information to other methods such as dead reckoning.

In another embodiment, the system and method can be used to teach and/or repeat complex vehicle routes in a building by decomposing the required non-linear and linear trajectories into linear grid pattern routes where the grid patterns are oriented in substantially the same manner as the dominant pattern of features in the ceiling of the building.

### Example Embodiments

Embodiment 1 is a system for drift correction of an autonomous vehicle using overhead features on a ceiling, the system comprising:
a computer processor;
   a digital memory accessible by the computer processor;
   a camera configured to be mounted on the autonomous vehicle, the camera being directed overhead to capture images of the overhead features to image one or more candidate ceiling lines; and
   computer-executable instructions implementing a heuristic algorithm stored in the digital memory, wherein when the computer processor executes the computer-executable instructions the computer processor:
      identifies the one or more candidate ceiling lines;
      calculates a score for each of the candidate ceiling lines, and based on the calculated scores selects a best line with the highest score;
      calculates change over time in the lateral position in the captured images of the selected best line to determine if the autonomous vehicle is drifting from a course substantially parallel to the best line;
      if the autonomous vehicle is determined to be drifting laterally from the course substantially parallel to the best line, then calculates and transmits a course correction instruction to the autonomous vehicle's steering system to reduce the drift; and
      if the score of the selected best line in subsequent images is less than a predefined threshold or the selected best line disappears from the view of the camera in the subsequent images, then calculates scores for each of a new set of candidate ceiling lines, and based on the calculated scores selects a new best line.

Embodiment 2 is the system of embodiment 1, wherein the instruction to the autonomous vehicle's steering system is calculated to cause the autonomous vehicle to alter the vehicle's course to be substantially parallel to the best line, and reduce the drift to approximately zero.

Embodiment 3 is the system of embodiment 1 or 2, wherein the heuristic algorithm for selecting the best line from the candidate ceiling lines comprises calculating the score for each of the candidate ceiling lines as:

score=λ₁*l+λ₂*w+λ₃*(posₓ−w_{image}/2)+λ₄*similarity(line,prev_{bestline})+λ₅θₗᵢₙₑ;

where
λᵢ, i=1 . . . 5, is the weight assigned to each feature;
l and w are the length and width of the line respectively;
posₓ is the position of the line at the vertical center of the image along the x-axis of the image;
w_{image} is the width of the image;
similarity(line, prev_{bestline}) is a measure of the similarity between the current line and the previous best line; and
θₗᵢₙₑ is the orientation of the best line with respect to the vehicle, with parallel being θₗᵢₙₑ=0.

Embodiment 4 is the system of any one of embodiments 1 to 3, wherein the system is further adapted to retain information about a previous best line to form a continuous best line by assigning higher weight to the similarity score in successive captured images.

Embodiment 5 is the system of any one of embodiments 1 to 6, wherein the new best line is selected to be the line in the new set of candidate ceiling lines with the highest score.

Embodiment 6 is a method of drift correction of an autonomous vehicle using overhead features performed by a computer processor, the method comprising:
providing a camera mounted onboard the autonomous vehicle, and directing the camera overhead to capture images of the overhead features to image one or more candidate ceiling lines; and
the computer processor executing a heuristic algorithm causing the computer processor to:
   identify the one or more candidate ceiling lines;
   calculate scores for each of the candidate ceiling lines, and based on the calculated scores select a best line;
   utilize the selected best line to determine if the autonomous vehicle is drifting from a desired course, and if so, then calculate and implement a course correction instruction to the autonomous vehicle's steering system to reduce the drift; and
   if the selected best line is no longer suitable or disappears from the view of the camera, then re-calculate scores for each of a new set of candidate ceiling lines, and based on the calculated scores select a new best line.

Embodiment 7 is the method of embodiment 6, wherein the instruction to the autonomous vehicle's steering system is calculated to cause the autonomous vehicle to alter the vehicle's course to be substantially parallel to the best line, and reduce the drift to approximately zero.

Embodiment 8 is the method of embodiment 6 or 7, wherein the heuristic algorithm for selecting a best ceiling line from candidate ceiling lines comprises calculating a score for each candidate ceiling line as:

score=λ₁*l+λ₂*w+λ₃*(posₓ−w_{image}/2)+λ₄*similarity(line,prev_{bestline})+λ₅θₗᵢₙₑ

where
λᵢ, i=1 . . . 5, is the weight assigned to each feature;
l and w are the length and width of the line respectively;
posₓ is the position of the line at the vertical center of the image along the x-axis of the image;
w_{image} is the width of the image;
similarity(line, prev_{bestline}) is a measure of the similarity between the current line and the previous best line; and
θₗᵢₙₑ is the orientation of the best line with respect to the vehicle, with parallel being θₗᵢₙₑ=0.

Embodiment 9 is the method of any one of embodiments 6 to 8, wherein the method further comprises retaining information about a previous best line to form a continuous best line in successive captured images.

Embodiment 10 is the method of any one of embodiments 6 to 9, wherein the instruction to the autonomous vehicle's steering system is calculated to cause the autonomous vehicle to alter the vehicle's course to be substantially parallel to the best line, and reduce the drift to substantially zero.

Generally, a computer, computer system, computing device, client or server, as will be well understood by a person skilled in the art, includes one or more than one electronic computer processor, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. It is the express intent of the inventors that a “processor” does not include a human; rather it is limited to be an electronic device, or devices, that perform digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

Multiple computers (also referred to as computer systems, computing devices, clients and servers) may be networked via a computer network, which may also be referred to as an electronic network or an electronic communications network. When they are relatively close together the network may be a local area network (LAN), for example, using Ethernet. When they are remotely located, the network may be a wide area network (WAN), such as the internet, that computers may connect to via a modem, or they may connect to through a LAN that they are directly connected to.

Computer-readable memory, which may also be referred to as a computer-readable medium or a computer-readable storage medium, which terms have identical (equivalent) meanings herein, can include any one or a combination of non-transitory, tangible memory elements, such as random access memory (RAM), which may be DRAM, SRAM, SDRAM, etc., and nonvolatile memory elements, such as a ROM, PROM, FPROM, OTP NVM, EPROM, EEPROM, hard disk drive, solid state disk, magnetic tape, CDROM, DVD, etc.) Memory may employ electronic, magnetic, optical, and/or other technologies, but excludes transitory propagating signals so that all references to computer-readable memory exclude transitory propagating signals. Memory may be distributed such that at least two components are remote from one another, but are still all accessible by one or more processors. A nonvolatile computer-readable memory refers to a computer-readable memory (and equivalent terms) that can retain information stored in the memory when it is not powered. A computer-readable memory is a physical, tangible object that is a composition of matter. The storage of data, which may be computer instructions, or software, in a computer-readable memory physically transforms that computer-readable memory by physically modifying it to store the data or software that can later be read and used to cause a processor to perform the functions specified by the software or to otherwise make the data available for use by the processor. In the case of software, the executable instructions are thereby tangibly embodied on the computer-readable memory. It is the express intent of the inventor that in any claim to a computer-readable memory, the computer-readable memory, being a physical object that has been transformed to record the elements recited as being stored thereon, is an essential element of the claim.

Software may include one or more separate computer programs configured to provide a sequence, or a plurality of sequences, of instructions to one or more processors to cause the processors to perform computations, control other devices, receive input, send output, etc.

It is intended that the invention includes computer-readable memory containing any or all of the software described herein. In particular, the invention includes such software stored on non-volatile computer-readable memory that may be used to distribute or sell embodiments of the invention or parts thereof.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

Unless expressly stated or otherwise clearly implied herein, the conjunction “or” as used in the specification and claims shall be interpreted as a non-exclusive “or” so that “X or Y” is true when X is true, when Y is true, and when both X and Y are true, and “X or Y” is false only when both X and Y are false.

The words “comprises” and “comprising”, when used in this specification and the claims, are used to specify the presence of stated features, elements, integers, steps or components, and do not preclude, nor imply the necessity for, the presence or addition of one or more other features, elements, integers, steps, components or groups thereof.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art. That is, persons skilled in the art will appreciate and understand that such modifications and variations are, or will be, possible to utilize and carry out the teachings of the invention described herein.

It will be appreciated by a skilled person that, where a device is described with multiple components having different and distinct functions and functionalities, such a device further includes any different assignment of functions and functionalities between and among the components that produces a like result. It will be further appreciated that a single component, whether or not explicitly named, recited, or described, may have the functionality ascribed to different components in addition to or in lieu of the operation of those components. It will be further appreciated that the functionality of a single component may be performed by multiple other components, whether or not explicitly named, recited, or described, in addition to or in lieu of the operation of the single component.

It will be appreciated by a skilled person that, where a series of actions, options, steps, or states are described in the context of a method, such a method further includes any different order or permutation of the actions, options, steps, or states that produces a like result. It will be further appreciated that different actions, options, steps, or states of such a method may be performed simultaneously, sequentially, or otherwise.

The terms “about” and “approximately” can be used to include any numerical value that can vary without changing the basic function of that value. It is used to indicate that a specified value should not be construed as a precise or exact value, and that some variation either side of that value is contemplated and within the intended ambit of the disclosure. When used with a range, “about” and “approximately” also disclose the range defined by the absolute values of the two endpoints, e.g., “about 2 to about 4” also discloses the range “from 2 to 4.” Generally, the terms “about” and “approximately” may refer to plus or minus 10% of the indicated number, depending on the context.

Numerical values in the specification and claims of this application should be understood to include numerical values which are the same when reduced to the same number of significant figures and numerical values which differ from the stated value by less than the experimental error of conventional measurement technique of the type described in the present application to determine the value.

The scope of the claims that follow is not limited by the embodiments set forth in the description. The claims should be given the broadest purposive construction consistent with the description and figures as a whole.

1. A system for drift correction of an autonomous vehicle using overhead features on a ceiling, the system comprising:
a computer processor;
a digital memory accessible by the computer processor;
a camera configured to be mounted on the autonomous vehicle, the camera being directed overhead to capture images of the overhead features to image one or more candidate ceiling lines; and
computer-executable instructions implementing a heuristic algorithm stored in the digital memory, wherein when the computer processor executes the computer-executable instructions the computer processor:
identifies the one or more candidate ceiling lines;
calculates a score for each of the candidate ceiling lines, and based on the calculated scores selects a best line with the highest score;
calculates change over time in the lateral position in the captured images of the selected best line to determine if the autonomous vehicle is drifting from a course substantially parallel to the best line;
if the autonomous vehicle is determined to be drifting laterally from the course substantially parallel to the best line, then calculates and transmits a course correction instruction to the autonomous vehicle's steering system to reduce the drift; and
if the score of the selected best line in subsequent images is less than a predefined threshold or the selected best line disappears from the view of the camera in the subsequent images, then calculates scores for each of a new set of candidate ceiling lines, and based on the calculated scores selects a new best line.

2. The system of claim 1, wherein the instruction to the autonomous vehicle's steering system is calculated to cause the autonomous vehicle to alter the vehicle's course to be substantially parallel to the best line, and reduce the drift to approximately zero.

3. The system of claim 1, wherein the heuristic algorithm for selecting the best line from the candidate ceiling lines comprises calculating the score for each of the candidate ceiling lines as:
score=λ₁*l+λ₂*w+λ₃*(posₓ−w_{image}/2)+λ₄*similarity(line,prev_{bestline})+λ₅θₗᵢₙₑ;
where
λᵢ, i=1 . . . 5, is the weight assigned to each feature;
l and w are the length and width of the line respectively;
posₓ is the position of the line at the vertical center of the image along the x-axis of the image;
w_{image} is the width of the image;
similarity(line, prev_{bestline}) is a measure of the similarity between the current line and the previous best line; and
θₗᵢₙₑ is the orientation of the best line with respect to the vehicle, with parallel being θₗᵢₙₑ=0.

4. The system of claim 3, wherein the instruction to the autonomous vehicle's steering system is calculated to cause the autonomous vehicle to alter the vehicle's course to be substantially parallel to the best line, and reduce the drift to approximately zero.

5. The system of claim 3, wherein the system is further adapted to retain information about a previous best line to form a continuous best line by assigning higher weight to the similarity score in successive captured images.

6. The system of claim 1, wherein the new best line is selected to be the line in the new set of candidate ceiling lines with the highest score.

7. A method of drift correction of an autonomous vehicle using overhead features performed by a computer processor, the method comprising:
providing a camera mounted onboard the autonomous vehicle, and directing the camera overhead to capture images of the overhead features to image one or more candidate ceiling lines; and
the computer processor executing a heuristic algorithm causing the computer processor to:
identify the one or more candidate ceiling lines;
calculate scores for each of the candidate ceiling lines, and based on the calculated scores select a best line;
utilize the selected best line to determine if the autonomous vehicle is drifting from a desired course, and if so, then calculate and implement a course correction instruction to the autonomous vehicle's steering system to reduce the drift; and
if the selected best line is no longer suitable or disappears from the view of the camera, then re-calculate scores for each of a new set of candidate ceiling lines, and based on the calculated scores select a new best line.

8. The method of claim 7, wherein the instruction to the autonomous vehicle's steering system is calculated to cause the autonomous vehicle to alter the vehicle's course to be substantially parallel to the best line, and reduce the drift to approximately zero.

9. The method of claim 7, wherein the heuristic algorithm for selecting a best ceiling line from candidate ceiling lines comprises calculating a score for each candidate ceiling line as:
score=λ₁*l+λ₂*w+λ₃*(posₓ−w_{image}/2)+λ₄*similarity(line,prev_{bestline})+λ₅θₗᵢₙₑ;
where
λᵢ, i=1 . . . 5, is the weight assigned to each feature;
l and w are the length and width of the line respectively;
posₓ is the position of the line at the vertical center of the image along the x-axis of the image;
w_{image} is the width of the image;
similarity(line, prev_{bestline}) is a measure of the similarity between the current line and the previous best line; and
θₗᵢₙₑ is the orientation of the best line with respect to the vehicle, with parallel being θₗᵢₙₑ=0.

10. The method of claim 9, wherein the method further comprises retaining information about a previous best line to form a continuous best line in successive captured images.

11. The method of claim 9, wherein the instruction to the autonomous vehicle's steering system is calculated to cause the autonomous vehicle to alter the vehicle's course to be substantially parallel to the best line, and reduce the drift to substantially zero.
